(19) United States
(12) Patent Application Publication
(10) Pub. No.: US 2025/0214867 A1
(43) Pub. Date: Jul. 3, 2025

(54) WATER TREATMENT MANAGEMENT APPARATUS, WATER TREATMENT MANAGEMENT SYSTEM, AND WATER TREATMENT METHOD

(71) Applicant: ORGANO CORPORATION, Tokyo (JP)

(72) Inventors: Naoya YOSHINAGA, Tokyo (JP); Yuki NAKAMURA, Tokyo (JP); Yusuke TAKAHASHI, Tokyo (JP); Kazushige TAKAHASHI, Tokyo (JP)

(73) Assignee: ORGANO CORPORATION, Tokyo (JP)

(21) Appl. No.: 18/848,591

(22) PCT Filed: Mar. 2, 2023
(86) PCT No.: PCT/JP2023/007811

§ 371 Date: Sep. 19, 2024

(30) Foreign Application Priority Data
Mar. 31, 2022 (JP) 2022-060358

(51) Int. Cl. C02F 1/04; C02F 1/32; C02F 1/42; C02F 1/44

(52) U.S. Cl. CPC C02F 1/045; C02F 1/32; C02F 1/42; C02F 1/441; C02F 2209/006; C02F 2209/20

(57) ABSTRACT

A water treatment management apparatus used for managing operation of a water treatment system which treats raw water includes: an evaluation-use pure water production unit which is equipped with a TOC (total organic carbon) removal device that performs a unit operation used to remove TOC components and through which the raw water is passed; a TOC measurement device for measuring the TOC concentration at least in the outlet water of the evaluation-use pure water production unit; a specific organic component measuring device for measuring the concentration of a specific organic component in water flowing through the evaluation-use pure water production unit; a calculation unit for performing calculation based on the TOC concentration and the concentration of the specific organic component; and a flow path control unit that controls the flow paths for supplying the raw water to the water treatment system based on the results of calculations.

### TECHNICAL FIELD

The present invention relates to a water treatment management apparatus and water treatment management system used for water treatment such as ultrapure water production by a water treatment system, and a water treatment method.

### BACKGROUND ART

In a water treatment system such as an ultrapure water production system that produces ultrapure water from raw water, it is necessary to pay attention to the quality of the raw water supplied to the water treatment system. For example, in ultrapure water production systems, reverse osmosis membrane (RO) treatment and ultraviolet (UV) oxidation treatment are performed to remove organic substances (total organic carbon (TOC) components) contained in the raw water. However, some organic components are easily removed by these treatments, while others are not. In the following description, TOC components that are difficult to remove by reverse osmosis membrane treatment or ultraviolet oxidation treatment, especially those that are difficult to decompose and remove by general ultraviolet oxidation treatment, are called persistent TOC components. Urea, for example, is known to be difficult to remove by reverse osmosis membrane treatment or general UV oxidation treatment, and is classified as a persistent TOC component. In addition to urea, there are other organic substances known to behave as persistent TOC components.

When persistent TOC components are mixed in the raw water, it may affect the quality of treated water at the outlet of water treatment systems such as ultrapure water production systems. Even if they are not persistent TOC components, there are organic substances that have a significant impact on the quality of treated water due to their presence in the raw water. For example, volatile organic compounds (VOCs) such as toluene and xylene, trihalomethanes such as chloroform and bromoform, tetramethylammonium hydroxide (TMAH), low molecular weight alcohols, etc. are known to sometimes affect the quality of treated water in water treatment systems when they are contained at high concentrations in the raw water, because they cannot be completely treated by reverse osmosis membrane treatment or ultraviolet oxidation treatment.

Until now, tap water, municipal water, and industrial water have been used as raw water supplied to ultrapure water production systems. In recent years, in order to make effective use of water resources, reclaimed or recovered water obtained from primary treatment of industrial wastewater or sewage treatment water is increasingly being reused as raw water. Unlike industrial water or the like, the quality of reclaimed and recovered water may not be stable, and reclaimed and recovered water may unexpectedly contain organic substances, so it is necessary to respond to such water quality fluctuations. However, in the case of an ultrapure water production system with a large treatment capacity, it takes time for the effects of changes in the quality of the raw water supplied to the system to reach the outlet, so it is not appropriate to respond to the changes in the quality of the raw water after detection of changes in the quality of the treated water obtained from the outlet. It is becoming more and more important to monitor the quality of raw water in ultrapure water production systems and to properly control the operation of the ultrapure water production systems according to the water quality.

Patent Literature 1 discloses that when a main ultrapure water production system is installed to produce ultrapure water to be supplied to a point-of-use from raw water, a sub ultrapure water production system is installed to monitor the quality of the raw water to perform controls. The sub ultrapure water production system has an equivalent configuration to the main ultrapure water production system to produce ultrapure water of similar quality. The TOC concentration of the ultrapure water obtained from the sub ultrapure water production system is measured, the quality of the raw water is evaluated based on this TOC concentration, and based on the evaluation results, the feed rate of the raw water supplied to the main ultrapure water production system, etc. is controlled. In the system described in Patent Literature 1, for example, when the TOC concentration in the ultrapure water obtained from the sub ultrapure water production system is high, the supply of the raw water to the main ultrapure water production system may be stopped, the raw water may be supplied to the main ultrapure water production system via an urea removal device, or the amount of ultraviolet irradiation in an ultraviolet irradiation device may be increased.

Patent Literature 2 discloses a water treatment management apparatus for the purpose of managing the operation of water treatment systems, such as ultrapure water production systems that supply ultrapure water to a point-of-use. In the technique described in Patent Literature 2, considering the water to be supplied to the water treatment system as target water, a evaluation-use pure water production unit equipped with a TOC removal device that performs a unit operation used to remove TOC components is provided separately from the water treatment system, the TOC concentrations at a plurality of measurement points in the evaluation-use pure water production unit are measured, and these TOC concentration values are analyzed to evaluate the target water. In the technique described in Patent Literature 2, the supply of the raw water to the water treatment system can be controlled according to the evaluation results. For example, if the target water, which is the raw water, is evaluated to contain persistent TOC components, is is possible to perform controls such that the raw water is not supplied to the water treatment system.

As a technique enabling on-line continuous measurement of urea concentration in raw water used for pure water production or the like, Patent Literature 3 discloses the quantification of urea by a colorimetric method using diacetylmonoxime, which is performed by flow injection analysis.

### CITATION LIST

### Patent Literature

Patent Literature 1: JP 2016-107249 A
Patent Literature 2: JP 2019-155275 A
Patent Literature 3: JP 2018-179545 A

### SUMMARY OF INVENTION

### Technical Problem

In the system described in Patent Literature 1, the persistent TOC component detected in the sub ultrapure water production system is not necessarily urea. Therefore, when persistent TOC components other than urea are included in the raw water, proper treatment cannot be performed, and persistent TOC components may remain in the outlet water of the main ultrapure water production system, resulting in deterioration of the quality of the resulting ultrapure water. In case of organic components which are easily removed by reverse osmosis membrane treatment or ultraviolet oxidation treatment, if the concentration of those organic components in the raw water is high, the organic components cannot be completely treated by reverse osmosis membrane treatment or ultraviolet oxidation treatment, which may affect the quality of the treated water. On the other hand, the system equipped with the water treatment management apparatus described in Patent Literature 2 has a problem that there is no other means than to limit the amount of raw water supplied to the water treatment system when it is evaluated that the raw water contains persistent TOC, resulting in a decrease in the utilization ratio of water resources.

The object of the present invention is to provide a water treatment management apparatus, a water treatment management system, and a water treatment method that monitor and evaluate raw water to enable a water treatment system to be operated appropriately when the raw water supplied to the water treatment system, such as an ultrapure water production system, may contain, for example, various persistent TOC components, and the above described organic components such as volatile organic compounds, trihalomethanes, tetramethylammonium hydroxide, and low molecular weight alcohols.

### Solution to Problem

According to an aspect of the present invention, the water treatment management apparatus used to manage operation of a water treatment system, includes: an evaluation-use pure water production unit which is equipped with a TOC removal device that performs a unit operation to remove TOC components and through which raw water to be supplied to the water treatment system is passed as target water; a TOC measuring device to measure the TOC concentration at least in outlet water of the evaluation-use pure water production unit; a specific organic component measuring device to measure the concentration of a specific organic component in water flowing through the evaluation-use pure water production unit; a calculation unit that performs calculation based on the TOC concentration and the concentration of the specific organic component; and a flow path control unit that controls flow paths for supplying the raw water to the water treatment system based on results of calculations performed by the calculation unit.

According to an aspect of the invention, the water treatment management system includes: the water treatment management apparatus according to the present invention; and a pretreatment flow path network with a plurality of flow paths arranged in series with each other in a pathway supplying the raw water to the water treatment system, wherein the water treatment management system controls a flow path for feeding the raw water to the water treatment system by selecting one or more of the flow paths in the pretreatment flow path network.

According to an aspect of the invention, the water treatment method for supplying raw water to a water treatment system includes: a step of passing the raw water as target water through a evaluation-use pure water production unit, which is separate from the water treatment system, and equipped with a TOC removal device that performs a unit operation used to remove TOC components; a first measurement step of measuring a TOC concentration at least in outlet water of the evaluation-use pure water production unit; a second measurement step of measuring a concentration of a specific organic component in water flowing through the evaluation-use pure water production unit; and a flow path control step of controlling flow paths that supplies the raw water to the water treatment system based on results of calculations based on the TOC concentration and the concentration of the specific organic component.

According to the water treatment management apparatus, water treatment management system, and water treatment method described above, it is possible to monitor and evaluate raw water to operate a water treatment system appropriately even when various persistent TOC components and other organic components are contained in the raw water.

### BRIEF DESCRIPTION OF THE DRAWINGS

FIG. 1 is a view showing a configuration of the water treatment management system according to the first embodiment;

FIG. 2 is a flowchart explaining an example of operation of the water treatment management system;

FIG. 3 is a view showing a configuration of the water treatment management apparatus in the second embodiment; and

FIG. 4 is a view showing a configuration of the water treatment management apparatus in the third embodiment.

### DESCRIPTION OF EMBODIMENTS

Next, the embodiments for implementing the present invention will be described with reference to the drawings.

### First Embodiment

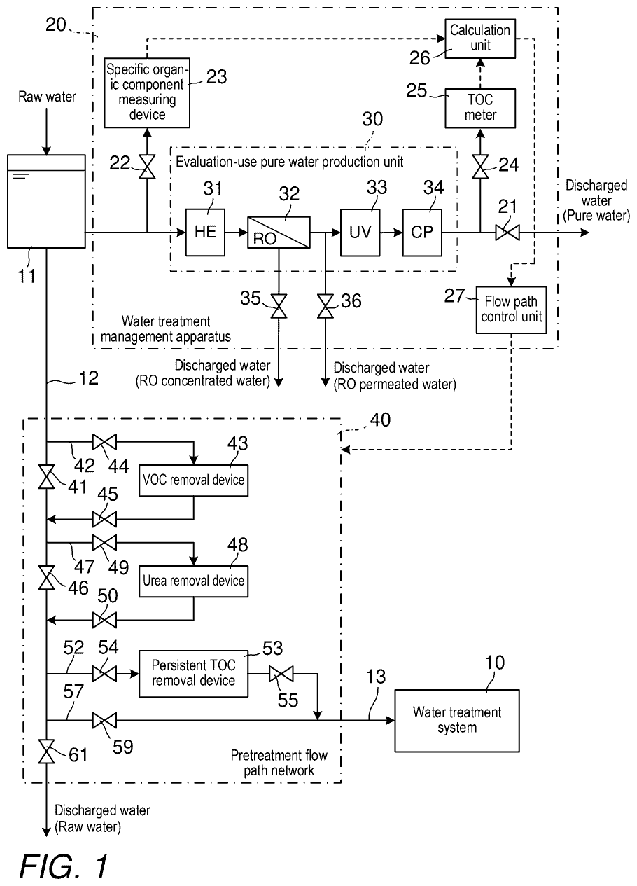

FIG. 1 shows the water treatment management system according to the first embodiment of the present invention. For example, assuming that there is water treatment system 10, such as an ultrapure water production system that produces ultrapure water from raw water, the water treatment management system supplies the raw water to water treatment system 10 with or without performing pretreatment, depending on the quality of the raw water. The water treatment management system includes: water treatment management apparatuses 20; and pretreatment flow path network 40.

Raw water tank 11 is provided to temporarily store the raw water to be supplied to water treatment system 10. The raw water is supplied to water treatment system 10 from raw water tank 11 by passing through pipe 12, pretreatment flow path network 40, and pipe 13 in this order. The raw water may be, for example, industrial water or recovered water, but in the following description, water to be supplied to water treatment system 10 will be broadly referred to as raw water. It may be configured such that raw water from different sources can be supplied to water treatment system 10 in a switchable manner.

Water treatment management apparatus 20 is used to manage the operation of water treatment system 10. Considering the raw water in raw water tank 11 as target water, water treatment management apparatus 20 monitors and evaluates the quality of the target water, and controls pretreatment flow path network 40 according to the evaluation results. In particular, water treatment control apparatus 20 confirms the presence of persistent TOC components in the target water, which is the raw water, and monitors their concentrations. Here, persistent TOC components are TOC components that are difficult to remove by reverse osmosis membrane treatment or ultraviolet oxidation treatment, especially those that are difficult to decompose and remove by ordinary ultraviolet oxidation treatment. Urea is one of persistent TOC components, but since urea is often the majority of persistent TOC components in raw water, it is more convenient to treat urea separately from other persistent TOC components for administrative purposes. As mentioned above, there are also organic substances that are not persistent TOC constituents but can affect the quality of treated water when included in raw water. Therefore, water treatment management apparatus 20 according to the present embodiment is configured to measure the concentration of a specific organic component as well as the overall concentration of persistent TOC components. The specific organic components here are one or more organic substances selected from organic substances such as urea, volatile organic compounds (such as toluene and xylene), trihalomethanes (such as chloroform and bromoform), tetramethylammonium hydroxide, low molecular weight alcohols.

Water treatment management apparatus 20 is equipped with evaluation-use pure water production unit 30, in which the raw water is supplied from raw water tank 11 as target water for evaluation of the raw water to produce pure water from the target water. Evaluation-use pure water production unit 30 consists of a combination of several types of TOC removal devices that perform unit operations used to remove TOC components. Here, evaluation-use pure water production unit 30 is equipped with: heat exchanger (HE) 31 for adjusting temperature of the target water; reverse membrane osmosis device (RO) 32 to which the outlet water of heat exchanger 31 is supplied; ultraviolet irradiation device (UV) 33 to which the permeated water (RO permeated water) from reverse osmosis membrane device 32 is supplied to perform ultraviolet oxidation treatment on this water; and ion exchange device to which the outlet water from ultraviolet irradiation device 33 is supplied to perform ion exchange treatment. The outlet water from the ion exchange device is the outlet water of evaluation-use pure water production unit 30. This outlet water is pure water. Reverse osmosis membrane device 32 may be a multi-stage configuration in which the permeated water from a reverse osmosis membrane at the preceding stage is fed to a reverse osmosis membrane at the subsequent stage. There are no restrictions on the type of reverse osmosis membrane used in reverse osmosis membrane device 32, but it is preferable to use an ultra-low pressure reverse osmosis membrane or a low pressure reverse osmosis membrane, for example, from the perspective of energy conservation in the pump. Reverse osmosis membrane device 32 is preferably operated at a recovery rate of 15 to 50%. There is no limit to the amount of ultraviolet irradiation in ultraviolet irradiation device 33, but it can be adjusted so that the irradiation amount is, for example, 0.05 to 3 kWh/m³. In the illustrated example, cartridge polisher (CP) 34 (also called a non-regenerative ion exchange device) filled with a mixed bed of anion exchange resin and cation exchange resin is used as the ion exchange device. The outlet water of evaluation-use pure water production unit 30 is discharged to the outside through valve 21. Reverse osmosis membrane device 32, ultraviolet irradiation device 33, and cartridge polisher 34 are all TOC removal devices that perform unit operations used to remove TOC components.

As pretreatment for the raw water supplied to water treatment management apparatus 20, treatment by passing water through a cartridge filter or activated carbon, or treatment by adding chemicals such as acids or alkalis may be performed. Water treatment management apparatus 20 may be also equipped with a membrane degassing device or an electrodeionization (EDI) device, depending on the water quality items to be monitored and their control level. The EDI device can be arranged in place of cartridge polisher 34, for example, to reduce the frequency of ion exchange resin replacement, or between reverse osmosis membrane device 32 and ultraviolet irradiation device 33 to improve TOC removal efficiency in ultraviolet irradiation device 33. Heat exchanger 31 may not be provided in water treatment management apparatus 20.

Since persistent TOC components are hardly removed by each TOC removal device in evaluation-use pure water production unit 30, the persistent TOC components in the target water appear in the outlet water of evaluation-use pure water production unit 30. Therefore, for the evaluation of persistent TOC components contained in the target water, in water treatment management apparatus 20, a portion of the outlet water of evaluation-use pure water production unit 30 is supplied via valve 24 to TOC meter 25, which is a TOC measuring device that measures TOC concentration. Since TOC components that can be easily removed by an ordinary TOC removal device are removed by the time they reach the outlet of evaluation-use pure water production unit 30, the TOC concentration measured by TOC meter 25 can be considered to be the carbon equivalent concentration of persistent TOC components. In order to measure the concentration of urea in the target water, a portion of the target water supplied to evaluation-use pure water production unit 30 in water treatment management apparatus 20 is branched and supplied to specific organic component measuring device 23 via valve 22. Specific organic component measuring device 23 is a measuring device that measures the concentration of the specific organic component in water mentioned above. When specific organic component measuring device 23 is configured as a urea meter to measure urea concentration in water, specific organic component measuring device 23 has a configuration as shown in, for example, Patent Literature 3. Or, specific organic component measuring device 23 may be a VOC meter that measures the concentration of volatile organic compounds in water, a device in which a urea meter and a VOC meter are combined, a trihalomethane meter that measures the concentration of trihalomethane, a TMAH meter that measures the concentration of tetramethylammonium hydroxide, an alcohol concentration meter that measures the concentration of alcohol such as methyl alcohol, ethyl alcohol, and isopropyl alcohol, or a combination of these measuring instruments.

Furthermore, water treatment management apparatus 20 is equipped with: calculation unit 26 that performs calculations based on the concentration of specific organic components measured by specific organic component measuring device 23 and the TOC concentration measured by TOC meter 25; and flow path control unit 27 that controls pretreatment flow path network 40 based on the calculation results in calculation unit 26. Calculation unit 26 and flow path control unit 27 are described below.

Next, pretreatment flow path network 40 will be explained. Pretreatment flow path network 40 provided between raw water tank 11 and water treatment system 10 is equipped with a plurality of flow paths, one of which feeds the raw water directly to water treatment system 10, while, in each of the remaining flow paths, a pretreatment device that performs pretreatment on the raw water is provided. Pretreatment flow path network 40 shown in FIG. 1 is used when specific organic component measuring device 23 consists of, for example, a urea meter and a VOC meter. Into this pretreatment flow path network 40, pipe 12 from raw water tank 11 is extends, and on this pipe 12, two valves 41 and 46 are installed in series so that valve 41 is upstream. Valve 61 is provided at the end of pipe 12 to discharge the raw water directly to the outside. Flow path 42 bypassing the both ends of valve 41 is provided. In flow path 42, VOC removal device 43 that removes volatile organic compounds in water is provided as the pretreatment device, and valves 44 and 45 are provided at the inlet and outlet of VOC removal device 43, respectively. VOC removal device 43 is a device that transfers volatile organic compounds in the raw water to the air side through gas-liquid contact with oxygen or nitrogen, for example. Alternatively, VOC removal device 43 may be a device equipped with a hollow-fiber membrane to remove volatile organic compounds by, for example, decompression degassing using, a vacuum pump.

Similarly, there is flow path 47 that bypasses both ends of valve 46. In flow path 47, urea removal device 48 is provided as the pretreatment device, and valves 49 and 50 are provided at the inlet and outlet of urea removal device 48, respectively. Urea removal device 48 is a device that removes urea from water, for example, by decomposing and removing urea with hypobromous acid generated when bromide salts and an oxidizing agent are added. Alternatively, urea decomposition device 48 may be a device that uses organisms to remove urea or a device that decomposes and removes urea through ultraviolet oxidation treatment with the addition of an appropriate oxidizing agent.

Between the outlet of valve 46 and valve 61, two flow paths 52 and 57 branch off from pipe 12, and the ends of these flow paths 52 and 57 both connect to pipe 13. In flow path 52, persistent TOC removal device 53 is provided as the pretreatment device, and valves 54 and 55 are provided at the inlet and outlet of persistent TOC removal device 53, respectively. Persistent TOC removal device 53 is a device that removes persistent TOC components in water, for example, by combining addition of persulfuric acid (peroxydisulfuric acid) or its salt with ultraviolet oxidation treatment. On the other hand, flow path 57 is a flow path to bypass persistent TOC removal device 53, and is equipped with only valve 59.

In this pretreatment flow path network 40, flow paths 42, 47 and 52, which are each equipped with a pretreatment device, are connected in series with each other to pipe 12 that supplies the raw water to water treatment system 10. By selecting one or more of flow paths 42, 47, 52 and 57 with valve 61 closed, it is possible to select whether to supply the raw water from raw water tank 11 to water treatment system 10 as it is, or whether to supply the raw water to water treatment system 10 after pretreatment in one or more of pretreatment devices, which are VOC removal device 43, urea removal device 48, and persistent TOC removal device 53, by passing the raw water through the pretreatment device. However, it is not possible to select both flow path 52 and flow path 57 at the same time. For example, if raw water is allowed to flow through flow path 42 by closing valve 41 and opening valves 44 and 45, the raw water is fed to water treatment system 10 through VOC removal device 43, and volatile organic compounds in the raw water are decomposed and removed by VOC removal device 43 as pretreatment for ultra pure water production, etc. In this case, the raw water from which volatile organic compounds have been removed is supplied to water treatment system 10. Similarly, if the raw water is allowed to flow through flow path 47 by closing valve 46 and opening valves 49 and 50, the raw water is fed to water treatment system 10 through urea removal device 48, and urea in the raw water is decomposed and removed by urea removal device 48. In this case, the raw water from which urea has been removed is still supplied to water treatment system 10. However, urea removal device 48 removes few persistent TOC components other than urea. If both flow paths 42 and 47 are selected, the raw water will pass through VOC removal device 43 and urea removal device 48 in this order.

In the example shown in FIG. 1, flow paths 42, 47 and 52 are provided in series, from upstream in the flow direction of the raw water, in the order of flow path 42 equipped with VOC removal device 43, flow path 47 equipped with urea removal device 48, and flow path 52 equipped with persistent TOC removal device 53. However, the order of arrangement of flow paths 42, 47 and 52 is not limited to this order. Piping and valves may be provided as appropriate to change the order of flow of the raw water in the three flow paths 42, 47 and 52, and the order of flow in these flow paths 42, 47 and 52 may be controlled based on the measured quality of the raw water. For example, the order of water flow to VOC removal device 43 and urea removal device 48 is not limited to this, and the flow path configuration in pretreatment flow path network 40 may be changed so that urea removal device 48 is watered before VOC removal device 43. When the raw water is passed through multiple pretreatment devices including persistent TOC removal device 53 in pretreatment flow path network 40, it is preferable that the raw water passes through persistent TOC removal device 53 at the last in the order from the perspective of reducing operating costs and other factors.

By closing valve 59 and opening valves 54 and 55 so that raw the water flows through flow path 52, the raw water is fed to water treatment system 10 through persistent TOC removal device 53, and the persistent TOC components in the raw water are decomposed and removed by persistent TOC removal device 43 as pretreatment for ultrapure water production, etc. In this case, the raw water from which persistent TOC components have been removed is supplied to water treatment system 10. Conversely, if valves 54 and 55 are closed and valve 59 is opened to allow the raw water to flow through flow path 57, the raw water is supplied to water treatment system 10 without going through persistent TOC removal device 53.

FIG. 1 has been used to describe the configuration of pretreatment flow path network 40 when urea and volatile organic compound concentrations is measured by specific organic component measuring device 23. In the water treatment management system equipped with such pretreatment flow path network 40, the controls is carried out so that: if the concentration of persistent TOC components in the raw water is below a predetermined level, the raw water in raw water tank 11 is fed directly to water treatment system 10 without pretreatment in pretreatment flow path network 40; and, if the concentration of persistent TOC components or specific organic components in the raw water exceeds the predetermined level, the raw water is fed to water treatment system 10 after pretreatment by at least one of VOC removal device 43, urea removal device 48, and persistent TOC removal device 53 in pretreatment flow path network 40. Calculation unit 26 and flow path control unit 27 are provided in water treatment management apparatus 20 to perform such controls.

Calculation unit 26 performs calculations based on the concentration of the specific organic component measured by specific organic component measuring device 23 and the TOC concentration measured by TOC meter 26. Flow path control unit 27 selects a flow path by controlling valves 41, 44 to 46, 49, 50, 54, 55, 59, and 61 of pretreatment flow path network 40 based on the calculation results obtained by calculation unit 26, and performs controls such that the raw water is supplied to water treatment system 10 with or without passing through one or more of VOC removal device 43, urea removal device 48 and persistent TOC removal device 53. In other words, flow path control unit 27 controls the flow path of the raw water to water treatment system 10 according to the calculation results by calculation unit 26. At this time, the operating conditions in each of VOC removal device 43, urea removal device 48 and persistent TOC removal device 53, which are the pretreatment device, may be controlled according to the calculation results by calculation unit 26. For example, for VOC removal device 43, the amount of air blown by a blower or the vacuum level of a vacuum pump may be controlled; for urea removal device 48, the amount of chemicals added may be controlled, and for persistent TOC removal device 53; the amount of chemicals added or the amount ultraviolet irradiation may be controlled.

An example of specific controls is described below. The TOC concentration measured by the TOC meter is denoted as C_{TOC}, the concentration of volatile organic compounds measured by the VOC meter of specific organic component measurement device 23 is denoted as C_{VOC}, and the urea concentration measured by the urea meter of specific organic component measurement device 23 is denoted as C_{U}. To achieve controls, several thresholds are set. The threshold value related to the TOC concentration C_{TOC} is T_{TOC}, the threshold value related to the volatile organic compound concentration C_{VOC} is T_{VOC}, the threshold value related to the urea concentration C_{U} is T_{U}, the threshold value related to the ratio (C_{VOC}/C_{TOC}) of the volatile organic compound concentration C_{VOC} to the TOC concentration C_{TOC} is T_{A}, and the threshold value related to the ratio (C_{U}/C_{TOC}) of the urea concentration C_{U} to the TOC concentration C_{TOC} is T_{B}. Then, based on the relationship between the measured concentration and each threshold value, calculation unit 26 and flow path control unit 27 perform controls based on the case classification as shown below.

(1) In normal conditions in which the concentration of persistent TOC components is small, i.e., condition

T_{TOC}>C_{TOC}

is satisfied, valves 44, 45, 49, 50, 54, 55 and 61 are closed and valves 41, 46, and 59 are opened so that the raw water is fed directly from pipe 12 to flow path 57 and directly to water treatment system 10.

(2) In high volatile organic compound concentration, i.e., four conditions:

T_{TOC}≤C_{TOC},

T_{VOC}≤C_{VOC},

T_{U}>C_{U}, and

C_{VOC}/C_{TOC}≥T_{A}

are all satisfied, valves 41, 49, 50, 54, 55 and 61 are closed and valves 44 to 46 and 59 are opened so that the raw water is fed from pipe 12 to flow path 42 to pass through VOC removal device 43 and then to water treatment system 10.

(3) When urea concentration is high, i.e., four conditions:

T_{TOC}≤C_{TOC},

T_{VOC}>C_{VOC},

T_{U}≤C_{U}, and

C_{U}/C_{TOC}≥T_{B}.

are all satisfied, valves 44 to 46, 54, 55 and 61 are closed and valves 41, 49, 50, and 59 are opened so that the raw water is fed from pipe 12 to flow path 47 to pass through urea removal device 48 and then to water treatment system 10.

(4) When both volatile organic compound and urea concentrations are high, i.e., five conditions:

T_{TOC}≤C_{TOC},

T_{VOC}≤C_{VOC},

T_{U}≤C_{U},

C_{VOC}/C_{TOC}≥T_{A}, and

C_{U}/C_{TOC}≥T_{B}.

are all satisfied, the valves are controlled in the same manner so that the raw water is fed to water treatment system 10 after passing through VOC removal device 43 and urea removal device 48 in sequence.

(5) The case of high concentration of TOC component, which is neither volatile organic compound nor urea, can be further subdivided into several cases. When three conditions

T_{TOC}≤C_{TOC},

T_{VOC}>C_{VOC}, and

T_{U}>C_{U}

are all satisfied, the valves are controlled in the same manner so that raw water is fed into flow path 52 to pass through persistent TOC removal device 53 and then to water treatment system 10. Also, when five conditions:

T_{TOC}≤C_{TOC},

T_{VOC}≤C_{VOC},

T_{U}≤C_{U},

C_{VOC}/C_{TOC}<T_{A}, and

C_{U}/C_{TOC}<T_{B}

are all satisfied, the valves are controlled in the same manner so that the raw water is fed to water treatment system 10 after passing through VOC removal device 43, urea removal device 48, and persistent TOC removal device 53 in sequence.

Persistent TOC removal device 53 can also decompose and remove both volatile organic compounds and urea, but its operating costs and other costs are higher than those of VOC removal device 43 and urea removal device 48. In the example of controls shown above, pretreatment of the raw water is performed in VOC removal device 43 and urea removal device 48 as much as possible, keeping in mind the reduction of operating costs. Therefore, depending on the combination of costs and other factors, the apparatus can perform pretreatment of the raw water by using only persistent TOC removal device 53 or combining persistent TOC removal device 53 with VOC removal device 43 or urea removal device 48, without being restricted to the above example of controls. The above control example is just one example, and the selection of flow paths in pretreatment flow path network 40 can be based on other algorithms. For example, if the urea concentration is high, the presence or absence of other TOC components can be determined from the difference between the TOC concentration measured by the TOC meter and the urea concentration, and the flow path switching and operating conditions of each of the removal devices in pretreatment flow path network 40 can be controlled based on the results of that determination.

In the present invention, the pretreatment devices installed in pretreatment flow path network 40 are not limited to VOC removal device 43, urea removal device 48, and persistent TOC removal device 53, but are selected according to the measurement items in water treatment management apparatus 20. In other words, when the concentration of a specific organic component is measured by specific organic component measuring device 23, a removal device to remove that specific organic component is installed in one of the flow paths of pretreatment flow path network 40, in order to remove that specific organic component from the raw water. For example, when specific organic component measuring device 23 is equipped with a trihalomethane meter, a trihalomethane removal device is provided in pretreatment flow path network 40 as the pretreatment device.

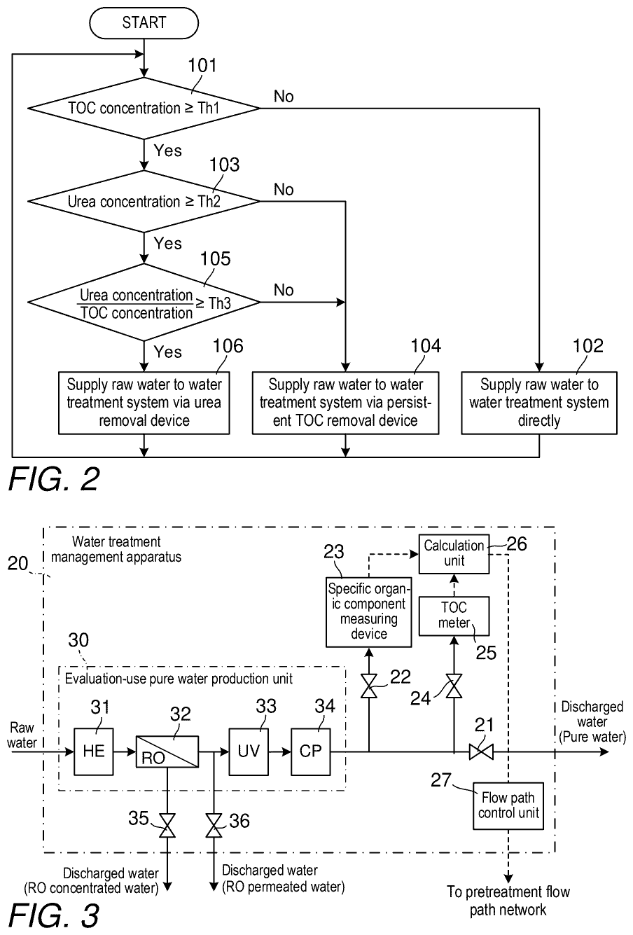

FIG. 2 is a flowchart that specifically explains the controls of the flow path in the present embodiment. Let us assume that in the water treatment management system shown in FIG. 1, specific organic component measuring device 23 only consists of a urea meter, and that none of valves 41 44, and 45, flow path 42, and VOC removal device 43 is provided in pretreatment flow path network 40. Therefore, there are three threshold values used for controls: first threshold value Th1 for TOC concentration, second threshold value Th2 for urea concentration, and third threshold value Th3 for the ratio between urea concentration and TOC concentration. First, in step 101, calculation unit 26 determines whether the TOC concentration measured by TOC meter 25 is above first threshold value Th1 or not. When the TOC concentration measured by TOC meter 25 is not less than first threshold value Th1, it is when the target water, which is the raw water, contains persistent TOC components above a certain level. Therefore, if the TOC concentration is less than first threshold value Th1 in step 101, flow path control unit 27 opens valves 46 and 59 in pretreatment flow path network 40 and closes the remaining valves 49, 50, 54, 55 and 61 in step 102, so that the raw water is supplied directly from pipe 12 through flow path 57 to water treatment system 10. If the TOC concentration is not less than first threshold value Th1 in step 101, calculation unit 26 then determines whether the urea concentration is above second threshold value Th2 or not in step 103. When the urea concentration is less than second threshold value Th2, this is a case where a persistent TOC component is included but it is not urea, so in step 104, flow path control unit 27 opens valves 46, 54 and 55 in pretreatment flow path network 40 and closes the remaining valves 49, 50, 59 and 61, so that the raw water is fed through flow path 52 to persistent TOC removal device 53 before being fed to water treatment system 10.

If the urea concentration is not less than second threshold value Th2 in step 103, calculation unit 26 determines whether [urea concentration/TOC concentration] is above third threshold value Th3 or not, in step 105. When [urea concentration/TOC concentration] is not less than third threshold value Th3, it is a case where urea accounts for a significant portion of the persistent TOC components in the raw water, so flow path control unit 27 opens valves 49, 50 and 59 in pretreatment flow path network 40 and closes the remaining valves 46, 54, 55 and 61 so that the raw water is treated by urea removal device 48 via flow path 47 before being fed to water treatment system 10 via flow path 57. On the other hand, if [urea concentration/TOC concentration] is less than the third threshold value Th3 in step 105, it is a case where persistent TOC components other than urea cannot be ignored, so flow path control unit 27 executes the process in step 104, and the raw water is treated by persistent TOC removal device 53 through flow path 57 before being supplied to water treatment system 10. In order to respond to ever-changing quality of the raw water, the process from step 101 is repeated after the flow path is selected in steps 102, 104 and 106.

In the control flow shown in FIG. 2, pretreatment of the raw water by urea removal device 48 or persistent TOC removal device 53 is performed when the TOC concentration is not less than first threshold value Th1. The choice of using either or both urea removal device 48 and persistent TOC removal device 53 for pretreatment of the raw water is not limited to that described using FIG. 2. For example, in the procedure shown in FIG. 2, the judgment process in step 105 may be assumed not to be performed, so that pretreatment of the raw water by urea removal device 48 is always performed when the urea concentration is not less than second threshold value Th2 in step 103. The first to third threshold values Th1 to Th3 in the procedure shown in FIG. 2 that is based on the TOC and urea concentrations are properly determined according to the configuration, application and the like of water treatment system 10. As an example, first threshold value Th1 is set between 0.5 and 5 ppb, preferably between 0.5 and 3 ppb, more preferably between 0.5 and 1 ppb. Second threshold value, Th2, is set as a carbon equivalent, for example, between 0.1 and 2 ppb, preferably between 0.1 and 1 ppb, more preferably between 0.1 and 0.3 ppb. Third threshold value, Th3, is set between 0.2 and 0.4, for example.

According to the treatment of the present embodiment described above, regardless of whether the persistent TOC component is urea or not, when the raw water to be supplied to water treatment system 10 contains a persistent TOC component, the raw water is supplied to water treatment system 10 after pretreatment to remove this persistent TOC component. This allows, for example, the water treatment system 10 to prevent deterioration in the quality of the ultrapure water obtained when water treatment system 10 is an ultrapure water production system. When the raw water contains organic components other than persistent TOC components that may affect the quality of the treated water in water treatment system 10, the raw water is fed to water treatment system 10 after pretreatment to remove the organic components, which similarly prevents a decrease in water quality at the outlet of water treatment system 10. In addition, persistent TOC removal device 53 that uses persulfuric acid, for example, is significantly more expensive to operate than VOC removal device 43 or urea removal device 48. According to the present embodiment, when the persistent TOC component in the raw water is mainly urea or when the raw water contains volatile organic compounds, since the pretreatment of the raw water is performed in VOC removal device 43 or urea removal device 48, reduction in the operating cost of the entire water treatment management system can be achieved.

### Second Embodiment

Water treatment management systems based on the present invention are not limited to those shown in FIG. 1. The water treatment management system according to the second embodiment will be described below. Similar to the first embodiment, the water treatment management system according to the second embodiment is equipped with water treatment management apparatus 20 and pretreatment flow path network 40, and pretreatment flow path network 40 in the second embodiment is the same as that used in the first embodiment. FIG. 3 is a view illustrating the water treatment management system of the second embodiment and depicts the configuration of water treatment management apparatus 20 provided in the water treatment management system.

Water treatment management apparatus 20 shown in FIG. 3 is configured by, in water treatment management apparatus 20 shown in FIG. 1, changing the position of specific organic component measuring device 23 so that part of the outlet water of evaluation-use pure water production unit 30 is supplied to specific organic component measuring device 23 via valve 22. Urea is also a persistent TOC component, but it may be removed to some extent in evaluation-use pure water production unit 30. Therefore, as shown in FIG. 3, measuring the urea concentration at the outlet water of evaluation-use pure water production unit 30 enables more precise control of the flow path in pretreatment flow path network 40. For specific organic components other than urea, it is possible to control the flow path in pretreatment flow path network 40 more precisely by measuring their concentration in the outlet water of evaluation-use pure water production unit 30 as shown in FIG. 3.

### Third Embodiment 3

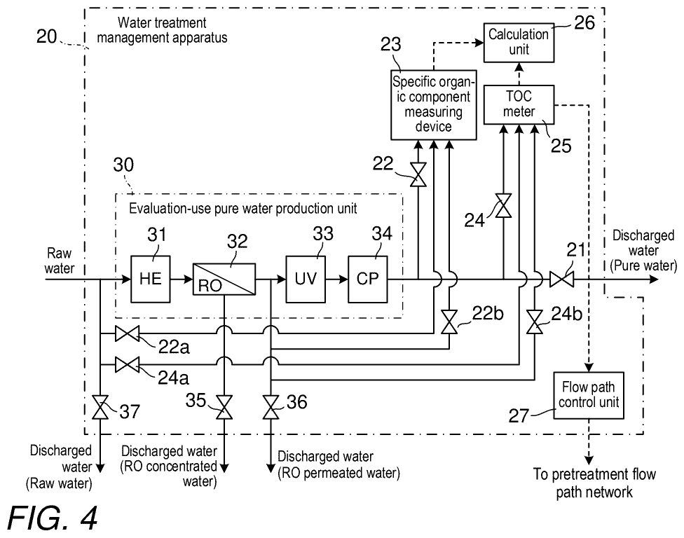

The measurement point for the concentration of a specific organic component or TOC concentration in evaluation-use pure water production unit 30 is not limited to one location, but can be multiple locations. FIG. 4 illustrates the water treatment management system according to the third embodiment. The water treatment management system according to the third embodiment also consists of water treatment management apparatus 20 and pretreatment flow path network 40. Pretreatment flow path network 40 in the third embodiment is similar to that used in the first embodiment.

Water treatment management apparatus 20 shown in FIG. 4 is configured by modifying water treatment management apparatus 20 shown in FIG. 3 so that part of the raw water supplied as target water to evaluation-use pure water production unit 30 is supplied to specific organic component measurement device 23 via valve 22a and to TOC meter 25 via valve 24a, and a portion of the permeated water (RO permeated water) of reverse osmosis membrane device 32 is supplied to specific organic component measurement device 23 via valve 22b and to TOC meter 25 via valve 24b. Furthermore, in water treatment management apparatus 20 in the third embodiment, valve 37 for discharging the raw water, which is supplied as the target water, to the outside is provided. By controlling the opening and closing of valves 22, 22a and 22b, specific organic component measuring device 23 can switch among the target water, RO permeate water, and the outlet water of evaluation-use pure water production unit 30 to measure the concentration of specific organic components in those waters. Similarly, by controlling the opening and closing of valves 24, 24a and 24b, TOC meter 25 can switch among measuring the TOC concentration of the target water, the TOC concentration of the RO permeate water, and the TOC concentration of the outlet water of evaluation-use pure production unit 30. By making it possible to measure the concentration of specific organic components and TOC concentration at multiple measurement points in this way, for example, the TOC removal rate in evaluation-use pure water production unit 30 can be determined from the TOC concentration of the target water and the outlet water of evaluation-use pure production unit 30. In the present embodiment, flow path control can be performed such that, if the TOC removal rate is large even when the TOC concentration of the target water is high, the raw water is supplied to water treatment system 10 through pretreatment flow path network 40 as in the above embodiments, and if the TOC removal rate is low, the raw water is discharged to the outside via valve 57 in pretreatment flow path network 40.

### EXAMPLES

The following Examples and Comparative Examples illustrate the invention in more detail. The Examples and Comparative Examples described below are merely illustrative and do not limit the present invention.

### Example 1

The water treatment management system shown in FIG. 1 was assembled. An ultrapure water production system was used as water treatment system 10. In water treatment management system 20, an ESPA2-4021, manufactured by Nitto Denko Corporation, with a membrane area of 3.5 m² was used as reverse osmosis membrane device 32, which was operated at a recovery rate of 50% and a flux of 0.6 m/d. A low-pressure ultraviolet oxidation device, manufactured by Photoscience Japan Corporation, was used as ultraviolet irradiation device 33, with an irradiation amount of 0.4 kWh/m³. A cartridge polisher ESP-2, manufactured by Organo Corporation, was used as cartridge polisher 34, with a water flow velocity of 60 (L/L−R)/h. A urea meter (online urea concentration meter ORUREA®, manufactured by Organo Corporation) was used to measure urea concentration as specific organic component measuring device 23. An on-line TOC concentration meter Siever 500RLe was used as TOC meter 25. Pretreatment flow path network 40 was equipped with urea removal device 48 and persistent TOC removal device 53 as pretreatment devices, while VOC removal device 43 was not provided. The urea concentration measured by the urea meter, which is specific organic component measuring device 23, was defined as the urea concentration in the inlet water of water treatment management apparatus 20, and the TOC concentration measured by TOC meter 25 was defined as the TOC concentration in the outlet water of water treatment management apparatus 20. Assuming that the control described using FIG. 2 is performed, first threshold value Th1 was set at 1 ppb, second threshold value Th2 was set at 0.6 ppb, and third threshold value Th3 was set at 0.4 ppb, with respect to the threshold values used in flow path control unit 27.

When simulated raw water was supplied as the raw water to water treatment management apparatus 20 and pretreatment flow path network 40, the urea concentration in the inlet water of water treatment management apparatus 20 was 8 ppb, which was above second threshold value Th2, and the TOC concentration in the outlet water of water treatment management apparatus 20 was 10 ppb, which was above first threshold value Th1. Since [urea concentration/TOC concentration] was 0.8 and above third threshold value Th3, it was determined that the persistent TOC component in the simulated raw water was urea. The opening and closing of each valve is controlled by flow path control unit 27 so that the simulated raw water is supplied to water treatment system 10 through urea removal device 48. The urea and TOC concentrations in the treated water (outlet water) of water treatment system 10 were then measured. The results are shown in Table 1.

### Example 2

The same water treatment management system and water treatment system 10 as in Example 1 were used, and simulated raw water different from that in Example 1 was supplied to water treatment management system 20 and pretreatment flow path network 40. Since the urea concentration in the inlet water of water treatment management apparatus 20 was less than 0.5 ppb and less than second threshold Th2, and the TOC concentration in the outlet water of water treatment management apparatus 20 was 10 ppb and above first threshold Th1, the persistent TOC components in the simulated raw water were determined to be organic components other than urea. At this time, [urea concentration/TOC concentration] was also less than 0.05 and less than third threshold value, Th3. The opening and closing of each valve is controlled by flow path control unit 27 so that the simulated raw water is supplied to water treatment system 10 via persistent TOC removal device 43. The urea and TOC concentrations in the treated water (outlet water) of water treatment system 10 were measured. The results are shown in Table 1.

### Comparative Example 1

A system with the same equipment configuration as in Example 2 was used, except that specific organic component measuring device 23, which is a urea meter, was removed from water treatment management apparatus 20 of the water treatment management system used in Example 2. Since the urea concentration is not measured in Comparative Example 1, when a persistent TOC component is detected, it is assumed to be urea, and control was executed so that the raw water pretreated by urea removal device 48 in pretreatment flow path network 40 was supplied to water treatment system 10. When the same simulated raw water used in Example 2 was supplied to water treatment management apparatus 20 and pretreatment flow path network 40, the TOC concentration in the outlet water of water treatment management apparatus 20 was 10 ppb, and it was determined that the simulated raw water contained persistent TOC components. The opening and closing of each valve is controlled by flow path control unit 27 so that the simulated raw water is supplied to water treatment system 10 via urea removal device 48. The urea and TOC concentrations in the treated water (outlet water) of water treatment system 10 were then measured. The results are shown in Table 1.

TABLE 1

| | Water treatment | | | |
|---|---|---|---|---|
| | management apparatus | | Water treatment system | |
| | Urea | TOC | Urea | TOC |
| | concentration in | concentration in | concentration in | concentration in |
| | inlet water [ppb] | outlet water [ppb] | outlet water [ppb] | outlet water [ppb] |
| Example 1 | 8 | 10 | <0.5 | <0.5 |
| Example 2 | <0.5 | 10 | <0.5 | <0.5 |
| Comparative | Not measured | 10 | <0.5 | 8 |
| Example 1 | | | | |

As shown in Table 1, in Example 1, the TOC concentration in the outlet water of water treatment management apparatus 20 was above first threshold value Th1, the urea concentration in the inlet water of water treatment management apparatus 20 was above second threshold value Th2, and [urea concentration/TOC concentration] was above third threshold value Th3. Therefore, it could be judged that the persistent TOC component in the simulated raw water is urea. Therefore, by treating the simulated raw water with urea removal device 48 before supplying it to water treatment system 10, the raw water that does not contain persistent TOC components could be supplied to water treatment system 10, and the quality of the outlet water, or treated water, of water treatment system 10 could be maintained.

Similarly, in Example 2, the TOC concentration in the outlet water of water treatment management apparatus 20 was above first threshold value Th1 and the urea concentration in the inlet water of water treatment management apparatus 20 was below second threshold value Th2, so the persistent TOC components in the simulated raw water were determined to be persistent TOC components other than urea. Therefore, by treating the simulated raw water with persistent TOC removal device 53 before supplying it to water treatment system 10, the raw water free of persistent TOC components could be supplied to water treatment system 10 and the quality of the treated water of water treatment system 10 could be maintained.

The simulated raw water used in Comparative Example 1 is the same as that used in Example 2, so it contains persistent TOC components and those persistent TOC components are other than urea. However, in Comparative Example 1, the urea concentration in the simulated raw water was not measured, and instead, the TOC concentration in the outlet water of water treatment management apparatus 20 was judged to contain urea by the fact that, for example, the TOC concentration was first threshold value Th1 or higher, and based on this judgment, the simulated raw water was treated with urea removal device 48 before supplying the simulated raw water to water treatment system 10. As a result, in Comparative Example 1, the raw water containing persistent TOC components other than urea was supplied to water treatment system 10, resulting in deterioration of the treated water quality of water treatment system 10 as shown in Table 1.

As shown by the above Examples and Comparative examples, the present invention makes it possible to evaluate, for example, whether the persistent TOC components are urea or other organic components when it is determined that the raw water to be supplied to the water treatment system contains the persistent TOC components, and to perform appropriate pretreatment of the raw water according to the evaluation results. This enables appropriate management of the operation of the water treatment system, especially enables stable operation of the water treatment system despite the quality of the raw water. In addition, when a persistent TOC component is found to be urea, the urea removal device removes the urea, thereby reducing the operating cost required to remove the persistent TOC component.

### REFERENCE SIGNS LIST

10 Water treatment systems;
11 Raw water tank;
20 Water treatment management apparatus;
23 Specific organic component measuring device;
25 TOC meter;
26 Calculation unit;
27 Feed water production unit;
30 Evaluation-use pure water production unit;
31 Heat exchanger (HE);
32 Reverse osmosis membrane device (RO);
33 Ultraviolet oxidation device (UV);
34 Cartridge polisher (CP);
40 Pretreatment flow path network;
43 VOC removal device;
48 Urea removal device; and
48 Persistent TOC removal device.

1. A water treatment management apparatus used to manage operation of a water treatment system, comprising:
an evaluation-use pure water production unit which is equipped with a TOC (total organic carbon) removal device that performs a unit operation to remove TOC components and through which raw water to be supplied to the water treatment system is passed as target water;
a TOC measuring device to measure a TOC concentration at least in outlet water of the evaluation-use pure water production unit;
a specific organic component measuring device to measure a concentration of a specific organic component in water flowing through the evaluation-use pure water production unit;
a calculation unit that performs calculation based on the TOC concentration and the concentration of the specific organic component; and
a flow path control unit that controls flow paths for supplying the raw water to the water treatment system based on results of calculations performed by the calculation unit.

2. The water treatment management apparatus according to claim 1, wherein the specific organic component measuring device measures the concentration of the specific organic component at least in the outlet water of the evaluation-use pure water production unit.

3. The water treatment management apparatus according to claim 1, wherein the calculation unit calculates a division value by dividing the concentration of the specific organic component by the TOC concentration, and the flow path control unit controls the flow paths according to the division value.

4. The water treatment management apparatus according to claim 1, wherein a plurality of measurement points are set in the evaluation-use pure water production unit including an inlet and an outlet of the evaluation-use pure water production unit, the TOC measuring device measures the TOC concentration at the plurality of measurement points, and the specific organic component measuring device measures the concentration of the specific organic component at the plurality of measurement points.

5. A water treatment management system, comprising:
the water treatment management apparatus according to claim 1; and
a pretreatment flow path network with a plurality of flow paths arranged in series with each other in a pathway supplying the raw water to the water treatment system,
wherein the water treatment management system controls a flow path for feeding the raw water to the water treatment system by selecting one or more of the flow paths in the pretreatment flow path network.

6. The water treatment management system according to claim 5, wherein pretreatment device that performs pretreatment on the raw water is provided in each of one or more flow paths of the pretreatment flow path network.

7. The water treatment management system according to claim 6, wherein a removal device that removes the specific organic component from the raw water is provided as the pretreatment device.

8. The water treatment management system according to claim 6, wherein a persistent TOC removal device is provided as the pretreatment device.

9. A water treatment method for supplying raw water to a water treatment system, comprising:
a step of passing the raw water as target water through a evaluation-use pure water production unit, which is separate from the water treatment system, and equipped with a TOC (total organic carbon) removal device that performs a unit operation used to remove TOC components;
a first measurement step of measuring a TOC concentration at least in outlet water of the evaluation-use pure water production unit;
a second measurement step of measuring a concentration of a specific organic component in water flowing through the evaluation-use pure water production unit; and
a flow path control step of controlling flow paths that supplies the raw water to the water treatment system based on results of calculations based on the TOC concentration and the concentration of the specific organic component.

10. The water treatment method according to claim 9, wherein the flow path control step is a step of selecting one flow path among one or more flow paths each of which performs pretreatment on the raw water and a flow path feeding the raw water directly to the water treatment system.
